(19) United States
(12) Patent Application Publication
(10) Pub. No.: US 2026/0316380 A1
(43) Pub. Date: Oct. 15, 2026

(54) FLAME HARDENING IN A THREE-DIMENSIONAL PRINTING PROCESS

(71) Applicant: International Business Machines Corporation, Armonk, NY (US)

(72) Inventors: Sarbajit Kumar RAKSHIT, Kolkata (IN); Sathya SANTHAR, Chennai (IN); Sridevi KANNAN, Chennai (IN)

(21) Appl. No.: 19/179,851

(22) Filed: Apr. 15, 2025

(51) Int. Cl. B29C 64/188; B29C 64/393; B33Y 40/00; B33Y 50/02

(52) U.S. Cl. CPC B29C 64/188; B29C 64/393; B33Y 40/00; B33Y 50/02

(57) ABSTRACT

In some implementations, a three-dimensional (3D) printing system may print a layer of a 3D printed object using a 3D printing head of the 3D printing system. The 3D printing system may heat the layer of the 3D printed object using a flame hardening nozzle of the 3D printing system to flame harden internal structures of the 3D printed object while the internal structures are exposed. The 3D printing system may quench, after heating the layer of the 3D printed object, the layer of the 3D printed object using a quenching nozzle of the 3D printing system to reduce a temperature of the layer of the 3D printed object. The 3D printing system may print additional layers of the 3D printed object using the 3D printing head to enclose the internal structures of the 3D printed object.

### BACKGROUND

This disclosure relates to three-dimensional (3D) printing, and more specifically, to flame hardening in a 3D printing process.

### SUMMARY

Some aspects described herein relate to a method. The method may include printing a layer of a 3D printed object using a 3D printing head of a 3D printing system. The method may include heating the layer of the 3D printed object using a flame hardening nozzle of the 3D printing system to flame harden internal structures of the 3D printed object while the internal structures are exposed. The method may include quenching, after heating the layer of the 3D printed object, the layer of the 3D printed object using a quenching nozzle of the 3D printing system to reduce a temperature of the layer of the 3D printed object. The method may include printing additional layers of the 3D printed object using the 3D printing head to enclose the internal structures of the 3D printed object.

Some aspects described herein relate to a computer system. The computer system may include a processor set, one or more computer-readable storage media, and program instructions stored on the one or more computer-readable storage media to cause the processor set to perform operations. The operations may include printing a first layer of a 3D printed object using a 3D printing head of a 3D printing system. The operations may include flame hardening, based on a first set of flame hardening parameters, the first layer of the 3D printed object using a flame hardening nozzle and a quenching nozzle of the 3D printing system. The operations may include printing a second layer of the 3D printed object using the 3D printing head. The operations may include flame hardening, based on a second set of flame hardening parameters, the second layer of the 3D printed object using the flame hardening nozzle and the quenching nozzle.

Some aspects described herein relate to a computer program product. The computer program product may include one or more computer-readable storage media and program instructions stored on the one or more computer-readable storage media to perform operations. The operations may include determining an estimated stress distribution for a 3D printed object that is to be manufactured by 3D printing. The operations may include determining, based on the estimated stress distribution, a first set of printing parameters for a first layer of the 3D printed object. The operations may include printing, based on the first set of printing parameters, the first layer of the 3D printed object using a 3D printing head of a 3D printing system. The operations may include determining, based on the estimated stress distribution, a first set of flame hardening parameters for the first layer of the 3D printed object. The operations may include flame hardening, based on the first set of flame hardening parameters, internal structures of the first layer of the 3D printed object using a flame hardening nozzle and a quenching nozzle of the 3D printing system. The operations may include determining, based on the estimated stress distribution, a second set of printing parameters for a second layer of the 3D printed object. The operations may include printing, based on the second set of printing parameters, the second layer of the 3D printed object using the 3D printing head. The operations may include determining, based on the estimated stress distribution, a second set of flame hardening parameters for the second layer of the 3D printed object. The operations may include flame hardening, based on the second set of flame hardening parameters, internal structures of the second layer of the 3D printed object using the flame hardening nozzle and the quenching nozzle.

### BRIEF DESCRIPTION OF THE DRAWINGS

FIG. 1 is a diagram of an example computing environment for flame hardening in a 3D printing process.

FIG. 2 is a diagram of an example implementation of a 3D printing system.

FIGS. 3A-3C are diagrams of an example implementation of flame hardening in a 3D printing process.

FIG. 4 is a diagram of an example implementation of flame hardening in a 3D printing process.

FIG. 5 is a flowchart of an example process associated with flame hardening in a 3D printing process.

FIG. 6 is a flowchart of an example process associated with flame hardening in a 3D printing process.

FIG. 7 is a flowchart of an example process associated with flame hardening in a 3D printing process.

### DETAILED DESCRIPTION

The following detailed description of example implementations refers to the accompanying drawings. The same reference numbers in different drawings may identify the same or similar elements.

Industrial components such as heavy machinery parts, industrial equipment, and/or propulsion system components may be susceptible to high-temperature corrosion as a result of being repeatedly exposed to extreme operating temperatures and environmental pollutants. High-temperature corrosion refers to a chemical reaction due to exposure to gases, solid or molten salts, and/or molten metals at elevated temperatures, such as temperatures at or above approximately 400 degrees Celsius for some types of materials. Such high-temperature corrosion may include carburization, chlorination, flue gas and deposit corrosion, nitridation, oxidation, and/or sulphidation, among other examples.

Flame hardening is a surface hardening technique that can be used to prevent, prolong, and/or reduce the severity of such corrosion. Flame hardening can involve elevating the temperature of a surface of an industrial component and then applying rapid quenching of the surface to rapidly cool the surface. The heating and subsequent rapid cooling of the surface modifies the structure of the material of the surface, and promotes the formation of hard material phases in the surface while inhibiting formation of softer phases.

Surface hardening techniques such as flame hardening may be limited to external surfaces and cannot be effectively applied to internal cross-section areas of an industrial component. The internal cross-section areas of some types of industrial components may include internal structures with complex geometries and lattice structures that are particularly susceptible to high-temperature corrosion. For example, cooling components (e.g., cooling couplings, propulsion nozzles) may include a complex arrangement of inner support structures that provide structural support for coolant passages through which a coolant flows to provide cooling to such components. These internal support structures may be repeatedly exposed to extreme operating temperatures and, as a result, may be prone to degradation and failure because of corrosion due to the exposure to such operating temperatures. This can lead to reduced performance, lifespan, and reliability of the cooling components.

In some implementations described herein, 3D printing and flame hardening systems are integrated into a 3D printing system for the manufacturing of industrial components. For example, a 3D printing head and a flame hardening nozzle of the 3D printing system may be operated such that an industrial component (or another type of object) is 3D printed and flame hardened in a singular process. The integration of the 3D printing head and the flame hardening nozzle in the 3D printing system enables the industrial component to be flame hardened layer by layer as the industrial component is 3D printed. This enables a complex and tailored flame hardening profile to be applied across the industrial component in an efficient and streamlined manner for increased manufacturing throughput. Moreover, applying flame hardening to the industrial component as the industrial component is 3D printed provides access to internal structures of the industrial component so that these internal structures can be flame hardened where otherwise these internal structures would be inaccessible after manufacturing of the industrial component.

By integrating 3D printing and flame hardening in the 3D printing system, a high degree of precision in the hardening of industrial components (including the internal structures of the industrial components) can be achieved, thereby reducing the likelihood of material failure under high-temperature conditions. Furthermore, the 3D printing system conserves processing resources, memory resources, and/or other resources that would have otherwise been consumed by manual calculations and trial-and-error methods for determining optimal flame hardening parameters in that the 3D printing system may utilize a combination of machine learning, artificial intelligence, and design and material analysis to generate a flame hardening profile that is to be applied across an industrial component that is to be 3D printed. .

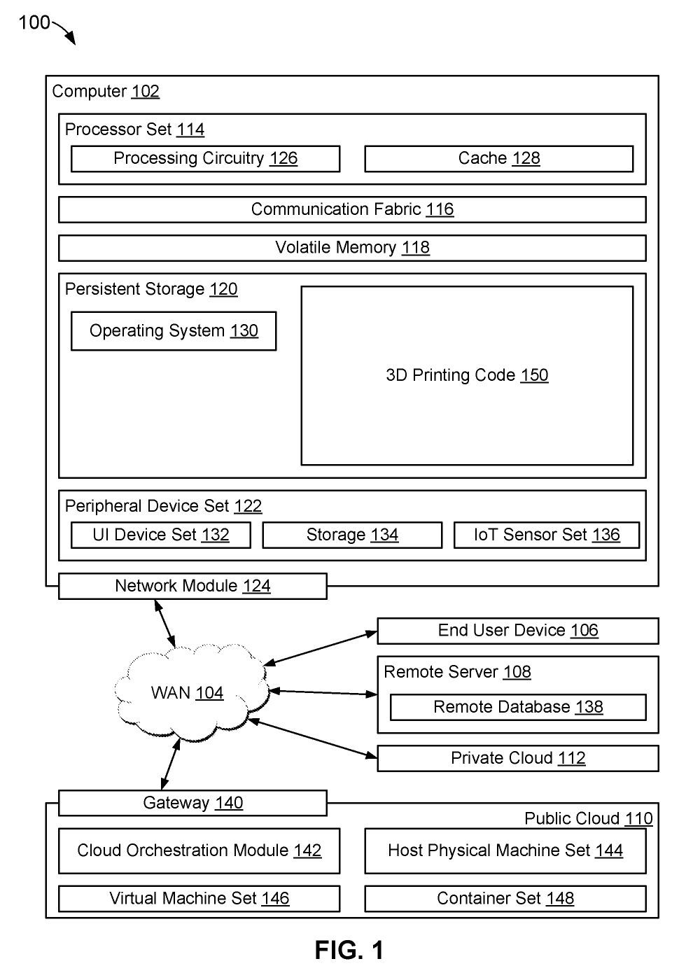

FIG. 1 is a diagram of an example computing environment 100 for flame hardening in a 3D printing process.

The computing environment 100 contains an example of an environment for the execution of at least some of the computer code involved in performing the inventive methods, such as 3D printing code 150. In addition to the 3D printing code 150, the computing environment 100 includes, for example, a computer 102, a wide area network (WAN) 104, an end user device (EUD) 106, a remote server 108, a public cloud 110, and a private cloud 112. In this embodiment, the computer 102 includes a processor set 114 (including processing circuitry 126 and a cache 128), communication fabric 116, volatile memory 118, persistent storage 120 (including an operating system 130 and the 3D printing code 150, as identified above), a peripheral device set 122 (including a user interface (UI) device set 132, storage 134, and an Internet of Things (IoT) sensor set 136), and a network module 124. The remote server 108 includes a remote database 138. The public cloud 110 includes a gateway 140, a cloud orchestration module 142, a host physical machine set 144, a virtual machine set 146, and a container set 148.

The computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as the remote database 138. As is well understood in the art of computer technology, and depending upon the technology, performance of a computer-implemented method may be distributed among multiple computers and/or between multiple locations. On the other hand, in this presentation of the computing environment 100, detailed discussion is focused on a single computer, specifically the computer 102, to keep the presentation as simple as possible. The computer 102 may be located in a cloud, even though it is not shown in a cloud in FIG. 1. On the other hand, the computer 102 is not required to be in a cloud except to any extent as may be affirmatively indicated.

Computer-readable program instructions are typically loaded onto the computer 102 to cause a series of operational steps to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as the cache 128 and the other storage media discussed below. The program instructions, and associated data, are accessed by the processor set 114 to control and direct performance of the inventive methods. In the computing environment 100, at least some of the instructions for performing the inventive methods may be stored in 3D printing code 150 in the persistent storage 120.

The communication fabric 116 is the signal conduction path that allows the various components of the computer 102 to communicate with each other. Typically, this fabric is made of switches and electrically conductive paths, such as the switches and electrically conductive paths that make up buses, bridges, and/or physical input / output ports, among other examples. Other types of signal communication paths may be used, such as fiber optic communication paths and/or wireless communication paths, among other examples.

The volatile memory 118 is any type of volatile memory now known or to be developed in the future. Examples include dynamic type random access memory (RAM) or static type RAM. Typically, the volatile memory 118 is characterized by random access, but this is not required unless affirmatively indicated. In the computer 102, the volatile memory 118 is located in a single package and is internal to the computer 102, but, alternatively or additionally, the volatile memory 118 may be distributed over multiple packages and/or located externally with respect to the computer 102.

The code included in the 3D printing code 150 typically includes at least some of the computer code involved in performing one or more operations described herein. In some implementations, the operations may include printing a layer of a 3D printed object using a 3D printing head of a 3D printing system; heating the layer of the 3D printed object using a flame hardening nozzle of the 3D printing system to flame harden internal structures of the 3D printed object while the internal structures are exposed; quench, after heating the layer of the 3D printed object, the layer of the 3D printed object using a quenching nozzle of the 3D printing system to reduce a temperature of the layer of the 3D printed object; and print additional layers of the 3D printed object using the 3D printing head to enclose the internal structures of the 3D printed object.

In some implementations, the operations may include printing a first layer of a 3D printed object using a 3D printing head of a 3D printing system; flame hardening, based on a first set of flame hardening parameters, the first layer of the 3D printed object using a flame hardening nozzle and a quenching nozzle of the 3D printing system; printing a second layer of the 3D printed object using the 3D printing head; and flame hardening, based on a second set of flame hardening parameters, the second layer of the 3D printed object using the flame hardening nozzle and the quenching nozzle.

In some implementations, the operations may include determine an estimated stress distribution for a 3D printed object that is to be manufactured by 3D printing; determine, based on the estimated stress distribution, a first set of printing parameters for a first layer of the 3D printed object; print, based on the first set of printing parameters, the first layer of the 3D printed object using a 3D printing head of a 3D printing system; determine, based on the estimated stress distribution, a first set of flame hardening parameters for the first layer of the 3D printed object; flame hardening, based on the first set of flame hardening parameters, internal structures of the first layer of the 3D printed object using a flame hardening nozzle and a quenching nozzle of the 3D printing system; determine, based on the estimated stress distribution, a second set of printing parameters for a second layer of the 3D printed object; print, based on the second set of printing parameters, the second layer of the 3D printed object using the 3D printing head; determine, based on the estimated stress distribution, a second set of flame hardening parameters for the second layer of the 3D printed object; and flame hardening, based on the second set of flame hardening parameters, internal structures of the second layer of the 3D printed object using the flame hardening nozzle and the quenching nozzle.

The peripheral device set 122 includes the set of peripheral devices of the computer 102. Data communication connections between the peripheral devices and the other components of the computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, the UI device set 132 may include components such as a display screen, speaker, microphone, wearable devices (such as goggles and smart watches), keyboard, mouse, printer, touchpad, game controllers, and haptic devices. The storage 134 is external storage, such as an external hard drive, or insertable storage, such as an SD card. The storage 134 may be persistent and/or volatile. In some embodiments, the storage 134 may take the form of a quantum computing storage device for storing data in the form of qubits. In embodiments where the computer 102 is required to have a large amount of storage (for example, where the computer 102 locally stores and manages a large database), then this storage may be provided by peripheral storage devices designed for storing very large amounts of data, such as a storage area network (SAN) that is shared by multiple, geographically distributed computers. The IoT sensor set 136 is made up of sensors that can be used in Internet of Things applications. For example, one sensor may be a thermometer and another sensor may be a motion detector.

The network module 124 is the collection of computer software, hardware, and firmware that allows the computer 102 to communicate with other computers through the WAN 104. The network module 124 may include hardware, such as modems or Wi-Fi signal transceivers, software for packetizing and/or de-packetizing data for communication network transmission, and/or web browser software for communicating data over the internet. In some embodiments, network control functions and network forwarding functions of the network module 124 are performed on the same physical hardware device. In other embodiments (for example, embodiments that utilize software-defined networking (SDN)), the control functions and the forwarding functions of the network module 124 are performed on physically separate devices, such that the control functions manage several different network hardware devices. Computer-readable program instructions for performing the inventive methods can typically be downloaded to the computer 102 from an external computer or external storage device through a network adapter card or network interface included in the network module 124.

The WAN 104 is any wide area network (for example, the internet) capable of communicating computer data over non-local distances by any technology for communicating computer data, now known or to be developed in the future. In some embodiments, the WAN 104 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and/or edge servers, among other examples.

The EUD 106 is any computer system that is used and controlled by an end user (for example, a customer of an enterprise that operates the computer 102), and may take any of the forms discussed above in connection with the computer 102. The EUD 106 typically receives helpful and useful data from the operations of the computer 102. For example, in a hypothetical case where the computer 102 is designed to provide a recommendation to an end user, this recommendation would typically be communicated from the network module 124 of the computer 102 through the WAN 104 to the EUD 106. In this way, the EUD 106 can display, or otherwise present, the recommendation to an end user. In some embodiments, the EUD 106 may be a client device, such as thin client, heavy client, mainframe computer, and/or desktop computer, among other examples.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by other computers, such as the computer 102. For example, in a hypothetical case where the computer 102 is designed and programmed to provide a recommendation based on historical data, then this historical data may be provided to the computer 102 from the remote database 138 of the remote server 108.

The public cloud 110 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of the public cloud 110 is performed by the computer hardware and/or software of the cloud orchestration module 142. The computing resources provided by the public cloud 110 are typically implemented by virtual computing environments that run on various computers making up the computers of the host physical machine set 144, which is the universe of physical computers in and/or available to the public cloud 110. The virtual computing environments (VCEs) typically take the form of virtual machines from the virtual machine set 146 and/or containers from the container set 148. It is understood that these VCEs may be stored as images and may be transferred among and between the various physical machine hosts, either as images or after instantiation of the VCE. The cloud orchestration module 142 manages the transfer and storage of images, deploys new instantiations of VCEs and manages active instantiations of VCE deployments. The gateway 140 is the collection of computer software, hardware, and firmware that allows the public cloud 110 to communicate through the WAN 104.

Some further explanation of VCEs will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to the public cloud 110, except that the computing resources are only available for use by a single enterprise. While the private cloud 112 is depicted as being in communication with the WAN 104, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, the public cloud 110 and the private cloud 112 are both part of a larger hybrid cloud.

Cloud computing services and/or microservices (not separately shown in FIG. 1): private cloud 112 and public clouds 110 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

FIG. 1 is provided as an example. Other examples may differ from what is described with regard to FIG. 1.

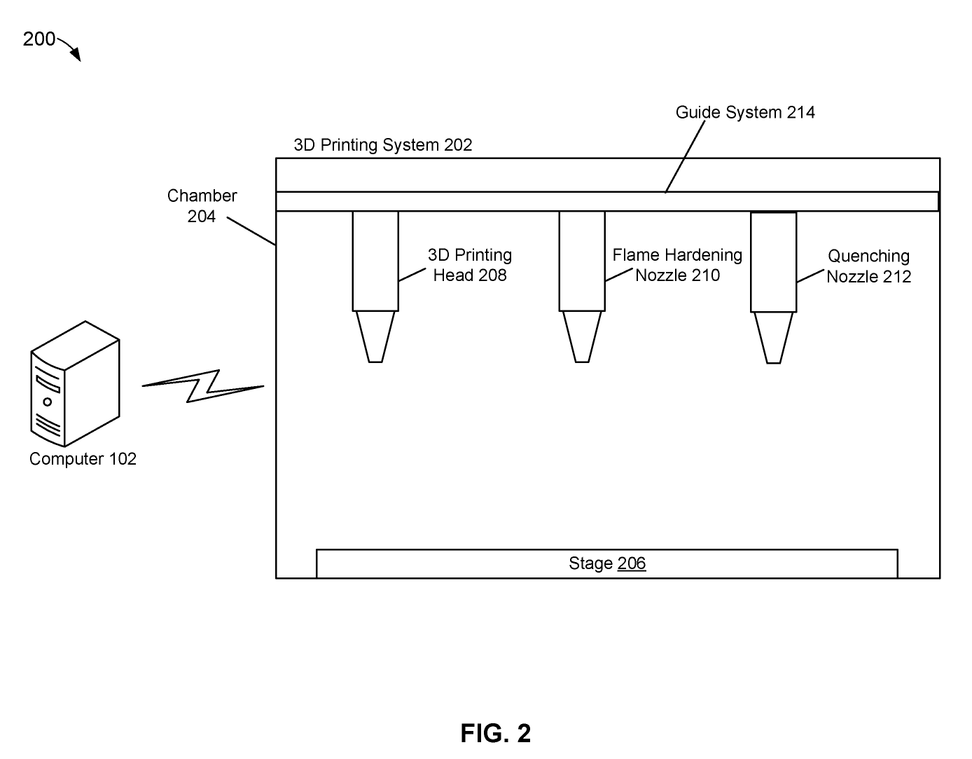

FIG. 2 is a diagram of an example implementation 200 of a 3D printing system 202. The 3D printing system 202 may be configured to 3D print objects using one or more 3D printing techniques, such as fused deposition, stereolithography, binder jetting, and/or powder bed fusion, among other examples. The objects that can be 3D printed by such 3D printing system 202 are not limited to any particular type of object, and may include industrial components, consumer components, and/or other types of components.

As shown in FIG. 2, the 3D printing system 202 may include a chamber 204 and a stage 206 within the chamber 204. A plurality of types of heads and/or nozzles may be located within the chamber 204 above the stage 206, including 3D printing head 208, a flame hardening nozzle 210, and a quenching nozzle 212. These components may be coupled to a guide system 214 that enables the 3D printing head 208, the flame hardening nozzle 210, and/or the quenching nozzle 212 to be moved and selectively positioned using computer numerical control (CNC).

The chamber 204 may include an internal volume and may include one or more sides that enclose the internal volume. Alternatively, one or more sides of the chamber 204 may be omitted such that the internal volume of the chamber is open an accessible.

In some implementations, the stage 206 includes a base plate, a chamber floor, a platen, and/or another type of horizontal surface that is configured to support and provide a substrate on which an object is 3D printed.

In some implementations, the stage 206 is a build platform that is surrounded by walls to define a volume in which a powder bed may be contained. A powder stock and powder roller may be located adjacent to the build platform and may be configured to provide additional layers of powder to the powder bed for 3D printing. The build platform may be configured to be raised and/or lowered as layers of an object are 3D printed.

In some implementations, the 3D printing head 208 is configured to provide the additive material for 3D printing an object. For example, the 3D printing head 208 may include a material jet, a material extrusion nozzle, and/or another type of head through which material is deposited onto the stage 206 (or onto an object that is being 3D printed on the stage 206).

In some implementations, the 3D printing head 208 is a fusion source that fuses material to an object that is being 3D printed. For example, the 3D printing head 208 may include a laser head that melts or sinters material of a powder bed on the stage 206 to fuse powder from the powder bed to the object being 3D printed. As another example, the 3D printing head 208 may include a laser head that cures a resin to solidify the resin to ad material to an object being 3D printed.

The flame hardening nozzle 210 may include a torch that emits a flame for flame hardening a surface of an object that is being 3D printed. The flame emitted by the flame hardening nozzle 210 may heat the surface of the object that is being 3D printed. The heat from the flame causes the surface of the object to reach a temperature above a temperature threshold associated with the material. For example, if the object is made of steel, the flame hardening nozzle 210 may heat the surface of the object to (or greater than) a temperature of approximately 750 degrees Celsius to approximately 900 degrees Celsius to modify the crystal structure of the material of the object. However, other temperatures and temperature ranges for flame hardening of an object are within the scope of the present disclosure.

The quenching nozzle 212 may include a nozzle through which a coolant is emitted to cool the surface of an object after a flame has been applied to the surface of the object using the flame hardening nozzle 210. The coolant may include water, oil, air and/or another quenching medium. The quenching nozzle 212 may rapidly cool the surface of the object, and the rapid cooling causes further modification of the crystal structure of the surface of the object for surface hardening.

The guide system 214 may include a combination of belts, gears, motors, structures, and/or other components that enable the 3D printing head 208, the flame hardening nozzle 210, and/or the quenching nozzle 212 to be moved according to a programmed path. In some implementations, the guide system 214 includes a gantry to which the 3D printing head 208, the flame hardening nozzle 210, and/or the quenching nozzle 212 is mounted. The computer 102 may control the movement of the 3D printing head 208, the flame hardening nozzle 210, and/or the quenching nozzle 212 along the gantry by CNC programming.

As further shown in FIG. 2, the computer 102 may be communicatively coupled to the 3D printing system 202 and may control various aspects of the operation of the 3D printing system 202 and/or the components included therein. The computer 102 may be a part of the 3D printing system 202 and may correspond to the control system of the 3D printing system 202. In some implementations, the computer 102 is embedded in the form factor of the 3D printing system 202. In some implementations, the computer 102 is located remote from the 3D printing system 202.

The computer 102 may communicate with components of the 3D printing system 202 over wired and/or wireless communication links using the network module 124 and/or the communication fabric 116, among other examples. The computer 102 may communicate with components of the 3D printing system 202 to control various aspects of the operation of the 3D printing system 202 to 3D print an object and/or to apply flame hardening to the object.

Various aspects of the flame hardening nozzle 210 may be controllable by the computer 102. For example, the computer 102 may provide one or more signals to the 3D printing system 202 to cause the flame hardening nozzle 210 to emit a flame that has a particular temperature, a particular shape, and/or a particular size, among other examples. Moreover, the computer 102 may provide one or more signals to the 3D printing system 202 to cause the flame hardening nozzle 210 to selectively emit a flame and to selectively cease emitting a flame. Additionally, the computer 102 may provide one or more signals to the 3D printing system 202 to cause the guide system 214 to move the flame hardening nozzle 210 in a particular pattern to flame harden an object that is being 3D printed.

Various aspects of the quenching nozzle 212 may be controllable by the computer 102. For example, the computer 102 may provide one or more signals to the 3D printing system 202 to cause the quenching nozzle 212 to emit a coolant that has a particular temperature, a particular flow rate, and/or a particular size, among other examples. Moreover, the computer 102 may provide one or more signals to the 3D printing system 202 to cause the quenching nozzle 212 to selectively emit coolant and to selectively cease emitting coolant. Additionally, the computer 102 may provide one or more signals to the 3D printing system 202 to cause the guide system 214 to move the quenching nozzle 212 in a particular pattern to quench an object that is being 3D printed.

FIG. 2 is provided as an example. Other examples may differ from what is described with regard to FIG. 2.

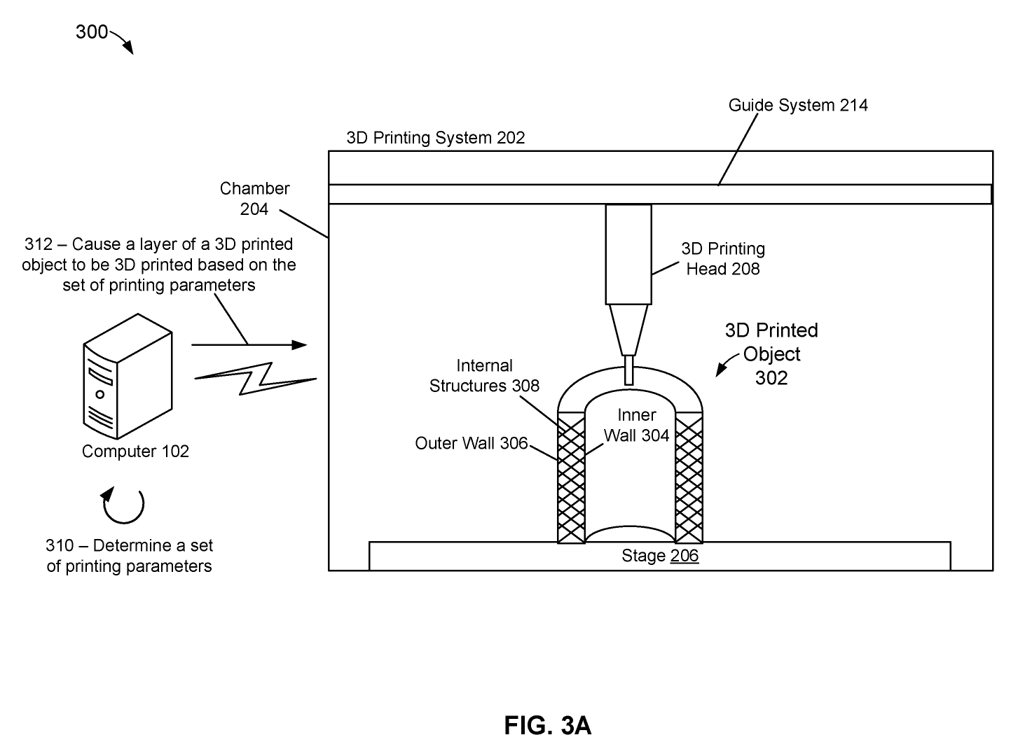

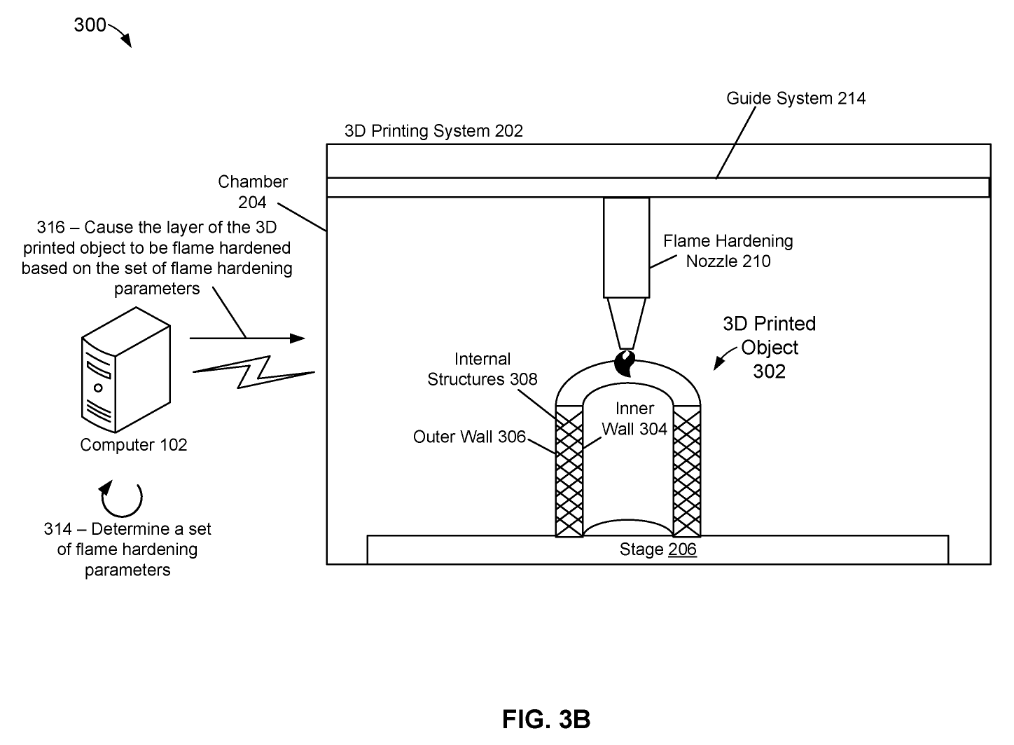

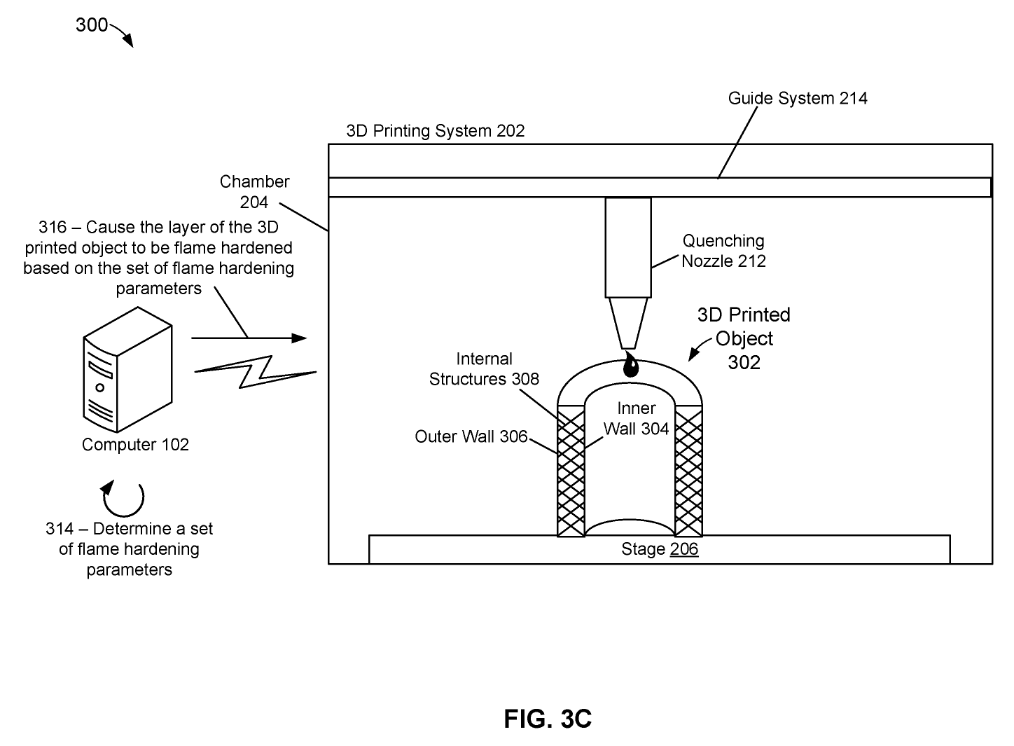

FIGS. 3A-3C are diagrams of an example implementation 300 of flame hardening in a 3D printing process. As shown in FIGS. 3A-3C, the 3D printing process may be performed to 3D print a 3D printed object 302 using the 3D printing system 202.

FIG. 3A illustrates a cross-section view of the 3D printed object 302. As shown in FIG. 3A, the 3D printed object 302 may be a component or system that has one or more inner spaces defined by an inner wall 304 and an outer wall 306. FIG. 3A further shows an inner space between the inner wall 304 and the outer wall 306 that includes internal structures 308 that are accessible during 3D printing of the 3D printed object 302. However, once 3D printing of the 3D printed object 302 is complete (or at some time prior to the completion of the 3D printing of the 3D printed object 302) the inner space is closed up so that the internal structures 308 are no longer accessible for flame hardening.

Accordingly, flame hardening for the 3D printed object 302 may be performed as the 3D printed object 302 is 3D printed so that flame hardening is applied to the 3D printed object 302 (including the internal structures 308) in a layer-by-layer manner. This enables the internal structures 308 to be flame hardened before the internal structures 308 are no longer accessible, and enables a complex and varied flame hardening profile to be applied across the 3D printed object 302.

As shown in FIG. 3A, at 310, the computer 102 may determine a set of printing parameters for 3D printing a layer of the 3D printed object 302. The set of printing parameters may include a printing speed for the layer, a movement path for the 3D printing head 208 for printing the layer, a material deposition rate for the 3D printing head 208, a power level (e.g., a laser power level) for the 3D printing head 208, and/or a type of material that is to be deposited, among other examples.

In some implementations, one or more of the printing parameters is based on the shape, geometry, size, orientation, and/or complexity of the layer that is to be printed. For example, the printing speed may be based on the size of internal structures 308 of the layer that is to be printed. As another example, the layer may be part of section of the 3D printed object 302 that is to be exposed to a particular set of environmental conditions when in use, and the material for the layer may be selected based on those environmental conditions.

As further shown in FIG. 3A, at 312, the computer 102 may provide one or more signals to the 3D printing system 202 to cause the 3D printing system 202 to 3D print the layer of the 3D printed object 302 based on the set of printing parameters. For example, the signal(s) may cause the guide system 214 of the 3D printing system 202 to move the 3D printing head 208 along the movement path determined for the set of printing parameters. As another example, the signal(s) may cause the 3D printing head 208 to dispense material at a rate that was determined for the set of printing parameters. As another example, the signal(s) may cause the 3D printing head 208 to emit a laser beam at a power level that was determined for the set of printing parameters.

3D printing the layer of the 3D printed object 302 may include 3D printing portions of the inner wall 304, portions of the outer wall 306, and/or portions of the internal structures 308, among other portions of the 3D printed object 302. The 3D printing head 208 may deposit material that is fused to the 3D printed object 302 to 3D print the layer. Additionally and/or alternatively, the 3D printing head 208 may emit a laser beam, ultraviolet light, and/or another type of electromagnetic radiation to fuse material of a material bed (e.g., a resin layer, a powder fusion bed) to the 3D printed object 302 to 3D print the layer. In some implementations, the 3D printing head 208 uses another technique to fuse material to the 3D printed object 302 to 3D print the layer.

As shown in FIGS. 3B and 3C, the 3D printing system 202 may use the flame hardening nozzle 210 and the quenching nozzle 212 to apply flame hardening to harden the surfaces of the layer that was (or that is being) 3D printed. The flame hardening nozzle 210 and the quenching nozzle 212 may be used to apply layer-by-layer surface hardening of the internal cross-section of the 3D printed object 302 while the internal structures 308 are accessible. The operation of the flame hardening nozzle 210 and the quenching nozzle 212 may be synchronized with the operation of the 3D printing head 208 to ensure consistent and effective application of surface hardening throughout the 3D printing process for the 3D printed object 302.

As shown in FIGS. 3B and 3C, at 314, the computer 102 may determine a set of flame hardening parameters for flame hardening the layer of the 3D printed object 302. At 316, the computer 102 may provide one or more signals to the 3D printing system 202 to cause the 3D printing system 202 to apply flame hardening to the layer of the 3D printed object 302 based on the set of flame hardening parameters.

The set of flame hardening parameters may include one or more parameters associated with the operation of the flame hardening nozzle 210, one or more parameters associated with the operation of the quenching nozzle 212, and/or one or more other parameters.

The one or more parameters associated with the operation of the flame hardening nozzle 210 may include a flame shape for the flame emitted by the flame hardening nozzle 210, a flame intensity (e.g., a rate of energy release by the flame), for the flame emitted by the flame hardening nozzle 210, a flame temperature for the flame emitted by the flame hardening nozzle 210, a depth of the flame hardening to be applied to the layer of the 3D printed object 302 (e.g., the depth of the heat penetration into the layer), a movement path for the flame hardening nozzle 210, a movement speed for the flame hardening nozzle 210, and/or a time duration for the flame hardening to be applied, among other examples.

The one or more parameters associated with the operation of the quenching nozzle 212 may include a type of coolant medium that is to be applied to the layer of the 3D printed object 302, a flow rate of the coolant medium, a temperature of the coolant medium, a depth of the cooling to be applied to the layer of the 3D printed object 302, a quenching speed for the layer (e.g., the temperature reduction rate for the layer), a movement path for the quenching nozzle 212, a movement speed for the quenching nozzle 212, and/or a time duration for the quenching to be applied, among other examples.

In some implementations, one or more of the flame hardening parameters are based on the shape, geometry, size, orientation, and/or complexity of the layer that is to be printed. For example, the movement speed and/or flame hardening temperature for the flame hardening nozzle 210 may be based on the size of internal structures 308 of the layer that is to be printed. As another example, the layer may be part of section of the 3D printed object 302 that is to be exposed to a particular set of environmental conditions (e.g., exposure to particular types of contaminants, the thermal profile that the section is to be subjected to during operation of the 3D printed object 302) when in use, and the depth of the flame hardening for the layer may be selected based on those environmental conditions.

In some implementations, the computer 102 may determine the set of flame hardening parameters using computational fluid dynamics techniques to evaluate the 3D temperature distribution across the entire 3D printed object 302 during its operation. The computer 102 may segment the 3D printed object 302 based on temperature and stress distribution, enabling the computer 102 to determine the thickness ranges for surface hardening in different sections of the 3D printed object 302.

As shown in FIG. 3B, based on the determined thickness of surface hardening for various sections of the 3D printed object 302, the computer 102 may control the flame hardening nozzle 210 to heat the layer to a determined temperature for a determined time duration. As shown in FIG. 3C, the computer 102 may control the quenching nozzle 212 to apply the coolant medium for rapid cooling.

Additionally and/or alternatively, the computer 102 may determine the set of flame hardening parameters by estimating the aggregated stresses across the sections of the 3D printed object 302 (e.g., that are estimated to be experienced by the 3D printed object 302 during operation of the 3D printed object 302) to generate a stress distribution profile for the 3D printed object 302 that includes both thermal stress distribution and mechanical stress distribution (e.g., vibration, pressure).

Based on the estimated operational parameters for the 3D printed object 302, the computer 102 may simulate the temperature distribution and mechanical stress distribution that are estimated to be applied on different sections of the 3D printed object 302.

To generate the stress distribution profile for the 3D printed object 302, the computer 102 may generate or receive a 3D model of the of the 3D printed object 302. The computer 102 may generate a mesh model, a point cloud model, and/or another type of localized model that includes a plurality of discrete localized points across the 3D printed object 302.

For each point in the point cloud, the computer 102 may determine the resultant thermal stress and mechanical stress that is estimated to be applied. Different sections of the 3D printed object 302 may be estimated to be subjected to different amounts of aggregated stresses, and these stresses may be estimated through the internal cross section of the 3D printed object 302 so that the stresses may be estimated for the internal structures 308 of the 3D printed object 302. The computer 102 may generate the stress distribution profile for the 3D printed object 302 based on resultant thermal and mechanical stresses for each point in the point cloud.

The computer 102 may also determine a corrosion profile for the 3D printed object 302 based on the generated stress distribution profile for the 3D printed object 302. The corrosion profile may identify sections of the 3D printed object 302 that are estimated to experience corrosion, the types of corrosion, and/or the severity of the corrosion so that the flame hardening parameters can be determined to apply flame hardening to reduce, minimize, and/or prevent such corrosion.

Based on the estimated corrosion profile and the stress distribution profile for 3D printed object 302, the computer 102 may determine the depth of the flame hardening that is to be applied to the layer of the 3D printed object 302. The depth of the flame hardening may be achieved by using particular parameters such as flame intensity, flame temperature, flame size and shape, and/or movement speed of the flame hardening nozzle 210, among other examples. Additionally and/or alternatively, the depth of the flame hardening may be achieved by using particular parameters such as coolant medium temperature, coolant medium type, and/or movement speed of the quenching nozzle 212, among other examples.

In some implementations, the computer 102 may continuously monitor the effectiveness of the flame hardening applied to the 3D printed object 302 and provide feedback to adjust the flame hardening parameters as needed. For example, the computer 102 may use a combination of real-time data and machine learning models to monitor the computer 102 and determine the effectiveness of the flame hardening. X-ray imaging and/or other scanning techniques and hardness testing techniques can be used to estimate the level of hardness that is achieved with the flame hardening.

Additionally and/or alternatively, the computer 102 may determine the flame hardening parameters using a machine learning model that has been trained on historical data on surface hardness and the influencing parameters for surface hardening with different materials. The computer 102 may use the feedback generated to identify the surface hardness amount and the depth of surface hardness based on different sets of flame hardening parameters that were used, and this feedback may be used to train and update the machine learning model to increase the accuracy and effectiveness of the selected flame hardening parameters.

The operations described in connection with FIGS. 3A-3C may be performed layer by layer to apply flame hardening to the 3D printed object 302 as the 3D printed object 302 is 3D printed. Moreover, the 3D printing head 208 may be used to print additional layers of the 3D printed object 302 to enclose the internal structures 308 of the 3D printed object 302 after the internal structures 308 have had surface hardening applied to them using the flame hardening techniques described herein.

FIGS. 3A-3C are provided as an example. Other examples may differ from what is described with regard to FIGS. 3A-3C.

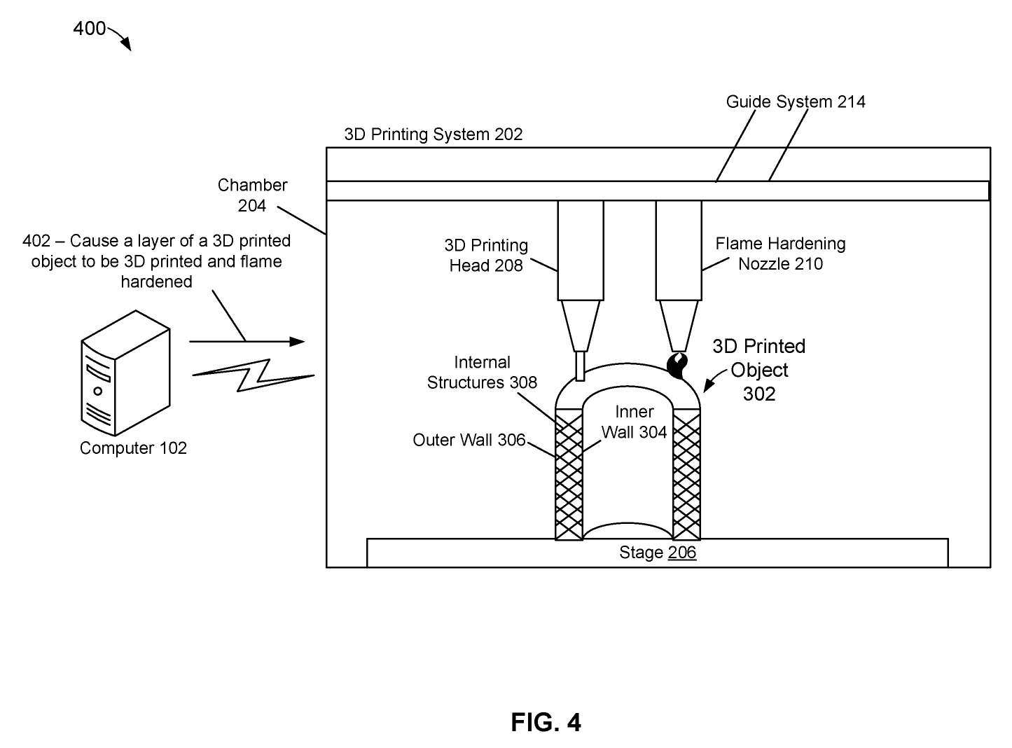

FIG. 4 is a diagram of an example implementation 400 of flame hardening in a 3D printing process. The example implementation 400 is similar to the example implementation 300, except that, at 402, the computer 102 may cause the 3D printing system 202 to simultaneously flame harden a layer of a 3D printed object 302 while the layer of the 3D printed object 302 is being 3D printed.

The 3D printing system 202 may simultaneously flame harden the layer of the 3D printed object 302 while the layer of the 3D printed object 302 is being 3D printed by heating a first portion of the layer of the 3D printed object 302 using the flame hardening nozzle 210 while printing a second portion of the layer of the 3D printed object 302 using the 3D printing head 208. The computer 102 may cause the guide system 214 to move the flame hardening nozzle 210 and the 3D printing head 208 along paths that do not interfere with each other to achieve a high level of productivity for the 3D printing system 202. The 3D printing head 208 may print the layer without affecting the portion(s) where the flame hardening nozzle 210 is applying flame hardening to the layer so that 3D printing productivity and surface hardening productivity can both be achieved together.

FIG. 4 is provided as an example. Other examples may differ from what is described with regard to FIG. 4.

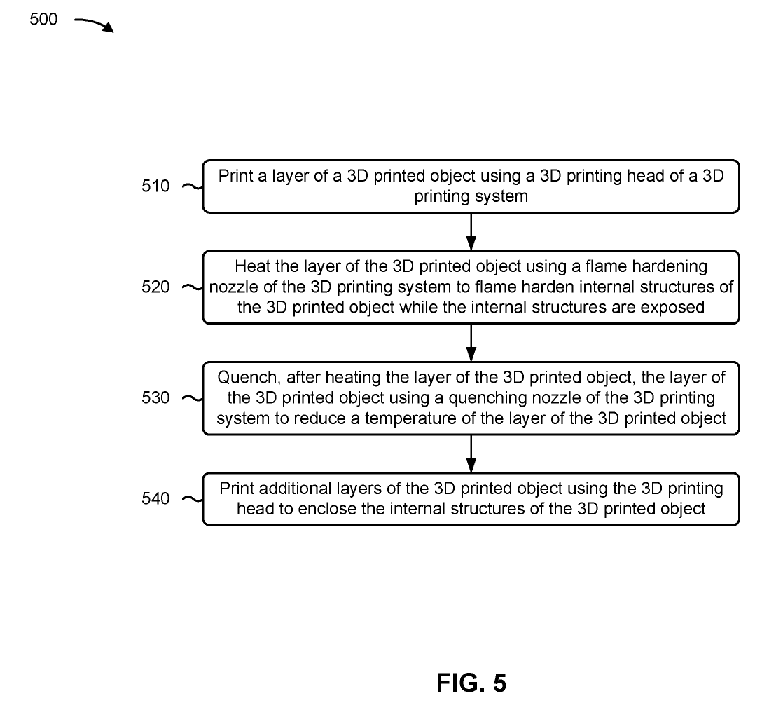

FIG. 5 is a flowchart of an example process 500 associated with flame hardening in a 3D printing process. One or more process blocks of FIG. 5 are performed by a 3D printing system (e.g., 3D printing system 202) and/or by another device or a group of devices separate from or including the 3D printing system 202, such as the computer 102. Additionally, or alternatively, one or more process blocks of FIG. 5 may be performed by one or more components of the computer 102, such as the processor set 114, the communication fabric 116, the volatile memory 118, the persistent storage 120, the peripheral device set 122, and/or the network module 124, among other examples.

As shown in FIG. 5, process 500 includes printing a layer of a 3D printed object using a 3D printing head of a 3D printing system (block 510). For example, the 3D printing system may print a layer of a 3D printed object using a 3D printing head of the 3D printing system, as described herein.

As further shown in FIG. 5, process 500 includes heating the layer of the 3D printed object using a flame hardening nozzle of the 3D printing system to flame harden internal structures of the 3D printed object while the internal structures are exposed (block 520). For example, the 3D printing system may heat the layer of the 3D printed object using a flame hardening nozzle of the 3D printing system to flame harden internal structures of the 3D printed object while the internal structures are exposed, as described herein.

As further shown in FIG. 5, process 500 includes quenching, after heating the layer of the 3D printed object, the layer of the 3D printed object using a quenching nozzle of the 3D printing system to reduce a temperature of the layer of the 3D printed object (block 530). For example, the 3D printing system 202 may quench, after heating the layer of the 3D printed object, the layer of the 3D printed object using a quenching nozzle of the 3D printing system to reduce a temperature of the layer of the 3D printed object, as described herein.

As further shown in FIG. 5, process 500 includes printing additional layers of the 3D printed object using the 3D printing head to enclose the internal structures of the 3D printed object (block 540). For example, the 3D printing system 202 may print additional layers of the 3D printed object using the 3D printing head to enclose the internal structures of the 3D printed object, as described above.

Process 500 may include additional aspects, such as any single aspect or any combination of aspects described below and/or in connection with one or more other processes described elsewhere herein.

In a first aspect, heating the layer of the 3D printed object comprises determining an estimated temperature distribution that the 3D printed object is estimated to experience during operation of the 3D printed object, and controlling, based on the estimated temperature distribution, a movement speed of the flame hardening nozzle during heating the layer of the 3D printed object.

In a second aspect, alone or in combination with the first aspect, heating the layer of the 3D printed object comprises determining an estimated stress distribution that the 3D printed object is estimated to experience during operation of the 3D printed object, and controlling, based on the estimated stress distribution, a movement speed of the flame hardening nozzle during heating the layer of the 3D printed object.

In a third aspect, alone or in combination with one or more of the first and second aspects, determining the estimated stress distribution comprises generating, using a 3D model of the 3D printed object, a point cloud model of the 3D printed object, determining estimated stresses that are to be applied to each point in the point cloud model of the 3D printed object, and determining, based on the estimated stresses, a stress distribution for each portion of the 3D printed object.

In a fourth aspect, alone or in combination with one or more of the first through third aspects, heating the layer of the 3D printed object using the flame hardening nozzle comprises determining, based on the stress distribution, different flame hardening parameters for different areas of the 3D printed object, and heating, based on the different flame hardening parameters, the layer of the 3D printed object using the flame hardening nozzle to apply flame hardening to the different areas of the 3D printed object.

In a fifth aspect, alone or in combination with one or more of the first through fourth aspects, heating the layer of the 3D printed object using the flame hardening nozzle comprises controlling, based on the different flame hardening parameters, at least one of a depth of the flame hardening for the internal structures of the 3D printed object, a time duration of the heating the layer of the 3D printed object, a flame intensity for the flame hardening nozzle, or a movement path for the flame hardening nozzle.

In a sixth aspect, alone or in combination with one or more of the first through fifth aspects, heating the layer of the 3D printed object using the flame hardening nozzle comprises heating a first portion of the layer of the 3D printed object using the flame hardening nozzle while printing a second portion of the layer of the 3D printed object using the 3D printing head.

In a seventh aspect, alone or in combination with one or more of the first through sixth aspects, heating the layer of the 3D printed object using the flame hardening nozzle comprises heating the layer of the 3D printed object using the flame hardening nozzle after the layer of the 3D printed object is printed.

In an eighth aspect, alone or in combination with one or more of the first through seventh aspects, process 500 includes receiving historical data on surface hardness and influencing parameters for flame hardening with different materials, and determining, using the historical data, a depth for the flame hardening of the layer of the 3D printed object, wherein heating the layer of the 3D printed object using the flame hardening nozzle comprises controlling the flame hardening nozzle to achieve the depth for the flame hardening of the layer of the 3D printed object.

Although FIG. 5 shows example blocks of process 500, in some implementations, process 500 includes additional blocks, fewer blocks, different blocks, or differently arranged blocks than those depicted in FIG. 5. Additionally, or alternatively, two or more of the blocks of process 500 may be performed in parallel.

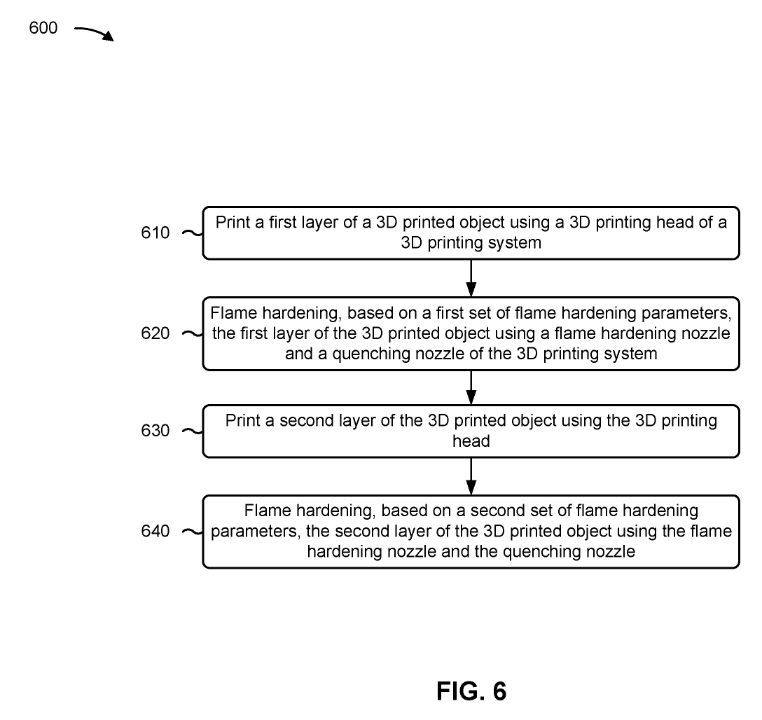

FIG. 6 is a flowchart of an example process 600 associated with flame hardening in a 3D printing process. One or more process blocks of FIG. 6 are performed by a 3D printing system (e.g., 3D printing system 202) and/or by another device or a group of devices separate from or including the 3D printing system 202, such as the computer 102. Additionally, or alternatively, one or more process blocks of FIG. 6 may be performed by one or more components of the computer 102, such as the processor set 114, the communication fabric 116, the volatile memory 118, the persistent storage 120, the peripheral device set 122, and/or the network module 124, among other examples.

As shown in FIG. 6, process 600 includes printing a first layer of a 3D printed object using a 3D printing head of a 3D printing system (block 610). For example, the 3D printing system may print a first layer of a 3D printed object using a 3D printing head of the 3D printing system, as described herein.

As further shown in FIG. 6, process 600 includes flame hardening, based on a first set of flame hardening parameters, the first layer of the 3D printed object using a flame hardening nozzle and a quenching nozzle of the 3D printing system (block 620). For example, the 3D printing system may flame harden, based on a first set of flame hardening parameters, the first layer of the 3D printed object using a flame hardening nozzle and a quenching nozzle of the 3D printing system, as described herein.

As further shown in FIG. 6, process 600 includes printing a second layer of the 3D printed object using the 3D printing head (block 630). For example, the 3D printing system may print a second layer of the 3D printed object using the 3D printing head, as described herein.

As further shown in FIG. 6, process 600 includes flame hardening, based on a second set of flame hardening parameters, the second layer of the 3D printed object using the flame hardening nozzle and the quenching nozzle (block 640). For example, the 3D printing system may flame harden, based on a second set of flame hardening parameters, the second layer of the 3D printed object using the flame hardening nozzle and the quenching nozzle, as described above.

Process 600 may include additional aspects, such as any single aspect or any combination of aspects described below and/or in connection with one or more other processes described elsewhere herein.

In a first aspect, process 600 includes determining the first set of flame hardening parameters based on a first corrosion level estimated for the first layer of the 3D printed object, and determining the second set of flame hardening parameters based on a second corrosion level estimated for the second layer of the 3D printed object.

In a second aspect, alone or in combination with the first aspect, determining the first set of flame hardening parameters based on the first corrosion level comprises determining, based on the first corrosion level estimated for the first layer of the 3D printed object, a first flame hardening depth for the first layer of the 3D printed object, and wherein determining the second set of flame hardening parameters based on the second corrosion level comprises determining, based on the second corrosion level estimated for the second layer of the 3D printed object, a second flame hardening depth for the second layer of the 3D printed object.

In a third aspect, alone or in combination with one or more of the first and second aspects, determining the first set of flame hardening parameters based on the first corrosion level comprises determining, based on the first corrosion level estimated for the first layer of the 3D printed object, a first flame hardening temperature for the first layer of the 3D printed object, and wherein determining the second set of flame hardening parameters based on the second corrosion level comprises determining, based on the second corrosion level estimated for the second layer of the 3D printed object, a second flame hardening temperature for the second layer of the 3D printed object.

In a fourth aspect, alone or in combination with one or more of the first through third aspects, determining the first set of flame hardening parameters based on the first corrosion level comprises determining, based on the first corrosion level estimated for the first layer of the 3D printed object, a first flame hardening time duration for the first layer of the 3D printed object, and wherein determining the second set of flame hardening parameters based on the second corrosion level comprises determining, based on the second corrosion level estimated for the second layer of the 3D printed object, a second flame hardening time duration for the second layer of the 3D printed object.

In a fifth aspect, alone or in combination with one or more of the first through fourth aspects, determining the first set of flame hardening parameters based on the first corrosion level comprises determining, based on the first corrosion level estimated for the first layer of the 3D printed object, a first movement speed of the flame hardening nozzle for flame hardening the first layer of the 3D printed object, and wherein determining the second set of flame hardening parameters based on the second corrosion level comprises determining, based on the second corrosion level estimated for the second layer of the 3D printed object, a second movement speed of the flame hardening nozzle for flame hardening the second layer of the 3D printed object.

In a sixth aspect, alone or in combination with one or more of the first through fifth aspects, determining the first set of flame hardening parameters based on the first corrosion level comprises determining, based on the first corrosion level estimated for the first layer of the 3D printed object, a first quenching speed for quenching the first layer of the 3D printed object using the quenching nozzle, and wherein determining the second set of flame hardening parameters based on the second corrosion level comprises determining, based on the second corrosion level estimated for the second layer of the 3D printed object, a second quenching speed for quenching the second layer of the 3D printed object using the quenching nozzle.

Although FIG. 6 shows example blocks of process 600, in some implementations, process 600 includes additional blocks, fewer blocks, different blocks, or differently arranged blocks than those depicted in FIG. 6. Additionally, or alternatively, two or more of the blocks of process 600 may be performed in parallel.

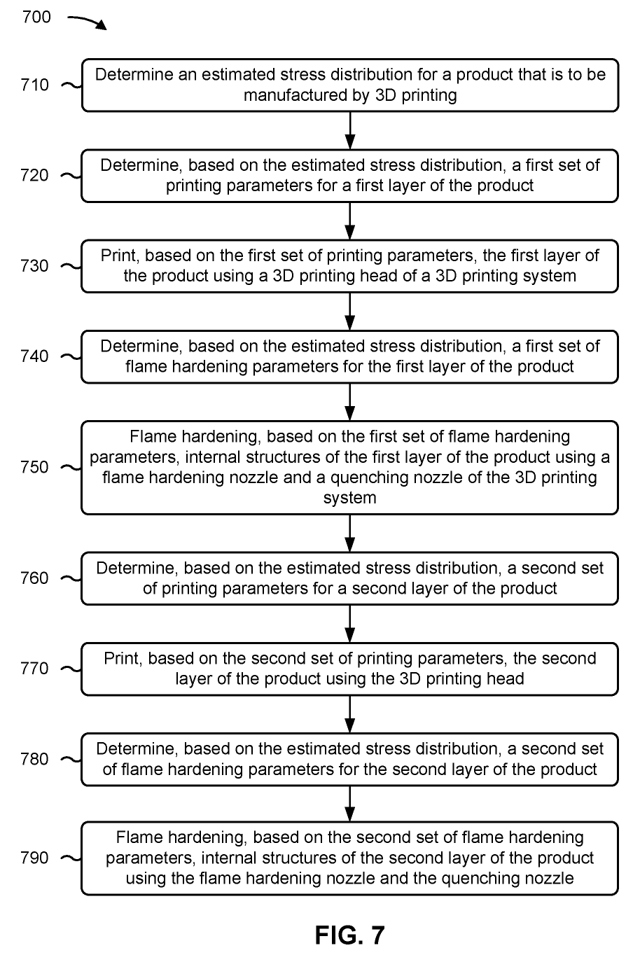

FIG. 7 is a flowchart of an example process 700 associated with flame hardening in a 3D printing process. One or more process blocks of FIG. 7 are performed by a 3D printing system (e.g., 3D printing system 202) and/or by another device or a group of devices separate from or including the 3D printing system 202, such as the computer 102. Additionally, or alternatively, one or more process blocks of FIG. 7 may be performed by one or more components of the computer 102, such as the processor set 114, the communication fabric 116, the volatile memory 118, the persistent storage 120, the peripheral device set 122, and/or the network module 124, among other examples.

As shown in FIG. 7, process 700 includes determining an estimated stress distribution for a 3D printed object that is to be manufactured by 3D printing (block 710). For example, the 3D printing system 202 may determine an estimated stress distribution for a 3D printed object that is to be manufactured by 3D printing, as described above.

As further shown in FIG. 7, process 700 includes determining, based on the estimated stress distribution, a first set of printing parameters for a first layer of the 3D printed object (block 720). For example, the 3D printing system may determine, based on the estimated stress distribution, a first set of printing parameters for a first layer of the 3D printed object, as described above.

As further shown in FIG. 7, process 700 includes printing, based on the first set of printing parameters, the first layer of the 3D printed object using a 3D printing head of the 3D printing system (block 730). For example, the 3D printing system may print, based on the first set of printing parameters, the first layer of the 3D printed object using a 3D printing head of the 3D printing system, as described above.

As further shown in FIG. 7, process 700 includes determining, based on the estimated stress distribution, a first set of flame hardening parameters for the first layer of the 3D printed object (block 740). For example, the 3D printing system may determine, based on the estimated stress distribution, a first set of flame hardening parameters for the first layer of the 3D printed object, as described above.

As further shown in FIG. 7, process 700 includes flame hardening, based on the first set of flame hardening parameters, internal structures of the first layer of the 3D printed object using a flame hardening nozzle and a quenching nozzle of the 3D printing system (block 750). For example, the 3D printing system may flame harden, based on the first set of flame hardening parameters, internal structures of the first layer of the 3D printed object using a flame hardening nozzle and a quenching nozzle of the 3D printing system, as described above.

As further shown in FIG. 7, process 700 includes determining, based on the estimated stress distribution, a second set of printing parameters for a second layer of the 3D printed object (block 760). For example, the 3D printing system may determine, based on the estimated stress distribution, a second set of printing parameters for a second layer of the 3D printed object, as described above.

As further shown in FIG. 7, process 700 includes printing, based on the second set of printing parameters, the second layer of the 3D printed object using the 3D printing head (block 770). For example, the 3D printing system may print, based on the second set of printing parameters, the second layer of the 3D printed object using the 3D printing head, as described above.

As further shown in FIG. 7, process 700 includes determining, based on the estimated stress distribution, a second set of flame hardening parameters for the second layer of the 3D printed object (block 780). For example, the 3D printing system may determine, based on the estimated stress distribution, a second set of flame hardening parameters for the second layer of the 3D printed object, as described above.

As further shown in FIG. 7, process 700 includes flame hardening, based on the second set of flame hardening parameters, internal structures of the second layer of the 3D printed object using the flame hardening nozzle and the quenching nozzle (block 790). For example, the 3D printing system may flame harden, based on the second set of flame hardening parameters, internal structures of the second layer of the 3D printed object using the flame hardening nozzle and the quenching nozzle, as described above.

Process 700 may include additional aspects, such as any single aspect or any combination of aspects described below and/or in connection with one or more other processes described elsewhere herein.

In a first aspect, the first set of printing parameters comprises a first printing speed for printing the first layer of the 3D printed object, wherein the second set of printing parameters comprises a second printing speed for printing the second layer of the 3D printed object, and wherein the first printing speed and the second printing speed are different printing speeds.

In a second aspect, alone or in combination with the first aspect, determining the first set of flame hardening parameters comprises determining, based on the estimated stress distribution, a required hardness for the internal structures of the first layer of the 3D printed object, and determining, based on the required hardness for the internal structures of the first layer of the 3D printed object, at least one of a flame hardening depth for the internal structures of the first layer of the 3D printed object, a flame hardening time duration for the internal structures of the first layer of the 3D printed object, or a flame hardening temperature for the internal structures of the first layer of the 3D printed object.

In a third aspect, alone or in combination with one or more of the first and second aspects, determining the first set of flame hardening parameters comprises determining a flame hardening path for the first layer of the 3D printed object so that the flame hardening nozzle does not interfere with operation of the 3D printing head when printing the first layer of the 3D printed object.

Although FIG. 7 shows example blocks of process 700, in some implementations, process 700 includes additional blocks, fewer blocks, different blocks, or differently arranged blocks than those depicted in FIG. 7. Additionally, or alternatively, two or more of the blocks of process 700 may be performed in parallel.

The foregoing disclosure provides illustration and description, but is not intended to be exhaustive or to limit the implementations to the precise forms disclosed. Modifications may be made in light of the above disclosure or may be acquired from practice of the implementations. For example, various aspects of this disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

A computer program product embodiment (“CPP embodiment” or “CPP”) is a term used in this disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, RAM, ROM, erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc), or any suitable combination of the foregoing. A computer-readable storage medium, as that term is used in this disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code - it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method comprising:
printing a layer of a three-dimensional (3D) printed object using a 3D printing head of a 3D printing system;
heating the layer of the 3D printed object using a flame hardening nozzle of the 3D printing system to flame harden internal structures of the 3D printed object while the internal structures are exposed;
quenching, after heating the layer of the 3D printed object, the layer of the 3D printed object using a quenching nozzle of the 3D printing system to reduce a temperature of the layer of the 3D printed object; and
printing additional layers of the 3D printed object using the 3D printing head to enclose the internal structures of the 3D printed object.

2. The method of claim 1, wherein heating the layer of the 3D printed object comprises:
determining an estimated temperature distribution that the 3D printed object is estimated to experience during operation of the 3D printed object; and
controlling, based on the estimated temperature distribution, a movement speed of the flame hardening nozzle during heating the layer of the 3D printed object.

3. The method of claim 1, wherein heating the layer of the 3D printed object comprises:
determining an estimated stress distribution that the 3D printed object is estimated to experience during operation of the 3D printed object; and
controlling, based on the estimated stress distribution, a movement speed of the flame hardening nozzle during heating the layer of the 3D printed object.

4. The method of claim 3, wherein determining the estimated stress distribution comprises:
generating, using a 3D model of the 3D printed object, a point cloud model of the 3D printed object;
determining estimated stresses that are to be applied to each point in the point cloud model of the 3D printed object; and
determining, based on the estimated stresses, a stress distribution for each portion of the 3D printed object.

5. The method of claim 4, wherein heating the layer of the 3D printed object using the flame hardening nozzle comprises:
determining, based on the stress distribution, different flame hardening parameters for different areas of the 3D printed object; and
heating, based on the different flame hardening parameters, the layer of the 3D printed object using the flame hardening nozzle to apply flame hardening to the different areas of the 3D printed object.

6. The method of claim 5, wherein heating the layer of the 3D printed object using the flame hardening nozzle comprises:
controlling, based on the different flame hardening parameters, at least one of:
a depth of the flame hardening for the internal structures of the 3D printed object,
a time duration of the heating the layer of the 3D printed object,
a flame intensity for the flame hardening nozzle, or
a movement path for the flame hardening nozzle.

7. The method of claim 1, wherein heating the layer of the 3D printed object using the flame hardening nozzle comprises:
heating a first portion of the layer of the 3D printed object using the flame hardening nozzle while printing a second portion of the layer of the 3D printed object using the 3D printing head.

8. The method of claim 1, wherein heating the layer of the 3D printed object using the flame hardening nozzle comprises:
heating the layer of the 3D printed object using the flame hardening nozzle after the layer of the 3D printed object is printed.

9. The method of claim 1, further comprising:
receiving historical data on surface hardness and influencing parameters for flame hardening with different materials; and
determining, using the historical data, a depth for the flame hardening of the layer of the 3D printed object,
wherein heating the layer of the 3D printed object using the flame hardening nozzle comprises:
controlling the flame hardening nozzle to achieve the depth for the flame hardening of the layer of the 3D printed object.

10. A computer system comprising:
a processor set;
one or more computer-readable storage media; and
program instructions stored on the one or more computer-readable storage media to cause the processor set to perform operations comprising:
printing a first layer of a three-dimensional (3D) printed object using a 3D printing head of a 3D printing system;
flame hardening, based on a first set of flame hardening parameters, the first layer of the 3D printed object using a flame hardening nozzle and a quenching nozzle of the 3D printing system;
printing a second layer of the 3D printed object using the 3D printing head; and
flame hardening, based on a second set of flame hardening parameters, the second layer of the 3D printed object using the flame hardening nozzle and the quenching nozzle.

11. The computer system of claim 10, further comprising:
determining the first set of flame hardening parameters based on a first corrosion level estimated for the first layer of the 3D printed object; and
determining the second set of flame hardening parameters based on a second corrosion level estimated for the second layer of the 3D printed object.

12. The computer system of claim 11, wherein determining the first set of flame hardening parameters based on the first corrosion level comprises:
determining, based on the first corrosion level estimated for the first layer of the 3D printed object, a first flame hardening depth for the first layer of the 3D printed object; and
wherein determining the second set of flame hardening parameters based on the second corrosion level comprises:
determining, based on the second corrosion level estimated for the second layer of the 3D printed object, a second flame hardening depth for the second layer of the 3D printed object.

13. The computer system of claim 11, wherein determining the first set of flame hardening parameters based on the first corrosion level comprises:
determining, based on the first corrosion level estimated for the first layer of the 3D printed object, a first flame hardening temperature for the first layer of the 3D printed object; and
wherein determining the second set of flame hardening parameters based on the second corrosion level comprises:
determining, based on the second corrosion level estimated for the second layer of the 3D printed object, a second flame hardening temperature for the second layer of the 3D printed object.

14. The computer system of claim 11, wherein determining the first set of flame hardening parameters based on the first corrosion level comprises:
determining, based on the first corrosion level estimated for the first layer of the 3D printed object, a first flame hardening time duration for the first layer of the 3D printed object; and
wherein determining the second set of flame hardening parameters based on the second corrosion level comprises:
determining, based on the second corrosion level estimated for the second layer of the 3D printed object, a second flame hardening time duration for the second layer of the 3D printed object.

15. The computer system of claim 11, wherein determining the first set of flame hardening parameters based on the first corrosion level comprises:
determining, based on the first corrosion level estimated for the first layer of the 3D printed object, a first movement speed of the flame hardening nozzle for flame hardening the first layer of the 3D printed object; and
wherein determining the second set of flame hardening parameters based on the second corrosion level comprises:
determining, based on the second corrosion level estimated for the second layer of the 3D printed object, a second movement speed of the flame hardening nozzle for flame hardening the second layer of the 3D printed object.

16. The computer system of claim 11, wherein determining the first set of flame hardening parameters based on the first corrosion level comprises:
determining, based on the first corrosion level estimated for the first layer of the 3D printed object, a first quenching speed for quenching the first layer of the 3D printed object using the quenching nozzle; and
wherein determining the second set of flame hardening parameters based on the second corrosion level comprises:
determining, based on the second corrosion level estimated for the second layer of the 3D printed object, a second quenching speed for quenching the second layer of the 3D printed object using the quenching nozzle.

17. A computer program product comprising:
one or more computer-readable storage media; and
program instructions stored on the one or more computer-readable storage media to perform operations comprising:
determining an estimated stress distribution for a three-dimensional (3D) printed object that is to be manufactured by 3D printing;
determining, based on the estimated stress distribution, a first set of printing parameters for a first layer of the 3D printed object;
printing, based on the first set of printing parameters, the first layer of the 3D printed object using a 3D printing head of a 3D printing system;
determining, based on the estimated stress distribution, a first set of flame hardening parameters for the first layer of the 3D printed object;
flame hardening, based on the first set of flame hardening parameters, internal structures of the first layer of the 3D printed object using a flame hardening nozzle and a quenching nozzle of the 3D printing system;
determining, based on the estimated stress distribution, a second set of printing parameters for a second layer of the 3D printed object;
printing, based on the second set of printing parameters, the second layer of the 3D printed object using the 3D printing head;
determining, based on the estimated stress distribution, a second set of flame hardening parameters for the second layer of the 3D printed object; and
flame hardening, based on the second set of flame hardening parameters, internal structures of the second layer of the 3D printed object using the flame hardening nozzle and the quenching nozzle.

18. The computer program product of claim 17, wherein the first set of printing parameters comprises a first printing speed for printing the first layer of the 3D printed object;
wherein the second set of printing parameters comprises a second printing speed for printing the second layer of the 3D printed object; and
wherein the first printing speed and the second printing speed are different printing speeds.

19. The computer program product of claim 17, wherein determining the first set of flame hardening parameters comprises:
determining, based on the estimated stress distribution, a required hardness for the internal structures of the first layer of the 3D printed object; and
determining, based on the required hardness for the internal structures of the first layer of the 3D printed object, at least one of:
a flame hardening depth for the internal structures of the first layer of the 3D printed object,
a flame hardening time duration for the internal structures of the first layer of the 3D printed object, or
a flame hardening temperature for the internal structures of the first layer of the 3D printed object.

20. The computer program product of claim 17, wherein determining the first set of flame hardening parameters comprises:
determining a flame hardening path for the first layer of the 3D printed object so that the flame hardening nozzle does not interfere with operation of the 3D printing head when printing the first layer of the 3D printed object.
